(19) United States
(12) Patent Application Publication
(10) Pub. No.: US 2026/0082456 A1
(43) Pub. Date: Mar. 19, 2026

(54) HEATING COIL FOR HIGH-FREQUENCY HEATER

(71) Applicant: TKE Co.,Ltd, Yatomi-shi, Aichi (JP)

(72) Inventors: Hideaki ITO, Yatomi-shi, Aichi (JP); Kazuhiro ABE, Yatomi-shi, Aichi (JP)

(21) Appl. No.: 18/705,544

(22) PCT Filed: Mar. 30, 2022
(86) PCT No.: PCT/JP2022/016283

§ 371 Date: May 15, 2025

(30) Foreign Application Priority Data
Oct. 28, 2021 (JP) 2021-176905

(51) Int. Cl. H05B 6/44; B33Y 80/00; H05B 6/42

(52) U.S. Cl. CPC H05B 6/44; B33Y 80/00; H05B 6/42

(57) ABSTRACT

A heating coil 1 is integrally formed by a modeling method repeating laying, melting, solidifying, and laminating of a powder containing a conductive material based on three-dimensional data, and includes a pair of plate-shaped grounding portions 2a, 2b, a pair of plate-shaped supporting portions 3a, 3b, and an annular heating unit 4. The pair of grounding portions 2a, 2b are for contact with an electrode through which a high-frequency current is flowed. The pair of supporting portions 3a, 3b are disposed to be perpendicular to the respective grounding portions 2a, 2b. The annular heating unit is disposed to connect distal ends of the supporting portions 3a, 3b to one another. The annular heating unit 4 has a shape in which a plurality of circumferential heating bodies Ha, Ha, . . . horizontally disposed at different height positions are coupled by a plurality of vertically disposed columnar heating bodies Hc, Hc, . . . .

### TECHNICAL FIELD

The present invention relates to a heating coil used for a high-frequency heater configured to heat a material to be worked using electromagnetic induction by a high frequency current.

### BACKGROUND ART

For increasing hardness of a portion close to a surface of a metal material to be worked (workpiece), processing (what is called, hardening process) in which the surface of the material to be worked is heated to a temperature equal to or more than a transformation point (austenite transformation point) of the metal, and then rapidly cooled is performed. As a method for performing the hardening process, a method (what is called, a high-frequency induction heating process) in which a material to be worked is heated by bringing a metal member (heating coil) to which a high-frequency current has been flowed close to a surface of the material to be worked using a high-frequency heater is widely employed. Then, the heating coil used for the high-frequency induction heating process usually includes a pair of grounding portions grounded to a high-frequency power supply, an annular heating unit that is externally fitted to a material to be worked, and a pair of supporting portions that couple (connect) the grounding portions to the heating unit. Furthermore, to suppress an excessive heat generation when a high frequency current is flowed, the annular heating unit is internally provided with a coolant passage through which a cooling medium, such as water, flows down.

When the hardening process is performed on a shaft-shaped (a columnar shape, a spherical shape, an annular shape, a shape in which a large diameter portion is continuous with a small diameter portion, and the like) material to be worked using the high-frequency induction heating process, the hardening process is performed while rotating the material to be worked around a center axis to uniformly perform the hardening process on a peripheral surface of the material to be worked in some cases.

However, when the hardening process is performed on the shaft-shaped material to be worked in which the large diameter portion is continuous with the small diameter portion using a heating coil with a simple annular heating unit, as illustrated in FIG. 8, an edge effect due to a magnetic flux F continuously generated at a position close to a groove shoulder part by an annular heating unit Hc causes a large quantity of eddy current E to flow at the groove shoulder part (part at which a diameter of the material to be worked changes). This causes the groove shoulder part of a material to be worked W to be excessively heated, and the groove shoulder part possibly becomes brittle due to coarsened crystal grains. Therefore, to avoid such a situation, the hardening process is performed on the material to be worked using a heating coil provided with an annular heating unit having a complicated shape that causes an induced current to flow in an axial direction of the material to be worked W (Patent Documents 1, 2).

Patent Document 1: Japanese Unexamined Patent Application Publication No. 2020-161218

Patent Document 2: Japanese Unexamined Patent Application Publication No. 2015-10260

### DISCLOSURE OF THE INVENTION

### Problems to be Solved by the Invention

However, the conventional heating coils as disclosed in Patent Documents 1, 2 need to be formed by bonding a plurality of components using a silver solder or the like because a coolant passage needs to be provided inside the heating unit regardless of the complicated shape of the annular heating unit. Therefore, the continuous use under a high output condition (under a processing condition of applying a high-frequency power supply of a high voltage) easily causes a damage, leading to a situation in which the cooling medium leaks out. Furthermore, since the above-described conventional heating coil needs to be formed by brazing a plurality of components, it is difficult to manufacture the products having the same characteristics with good reproducibility in the manufacture, and this causes a malfunction that variation occurs in the quality of the material to be worked to be heated.

It is an object of the present invention to solve the above-described problems of the conventional heating coil for a high-frequency heating process, and provide a heating coil for a high-frequency heater reduced in occurrence of a situation in which a large quantity of current flows at a groove shoulder part and the groove shoulder part is excessively heated even in a shaft-shaped material to be worked in which a large diameter portion is continuous with a small diameter portion, enabling a hardening process uniformly performed on a superficial layer, and enabling easily manufacturing ones having same characteristics at low cost with good reproducibility in the manufacture.

### Solutions To The Problems

In the present invention, an invention described in claim 1 is a heating coil used for a high-frequency heater configured to heat a material to be worked using electromagnetic induction by a high-frequency current. The heating coil is integrally formed by a modeling method repeating laying, melting, solidifying, and laminating of a powder containing a conductive material based on three-dimensional data (hereinafter referred to as a partial welding lamination method of conductive material powder layer), or a modeling method laminating a melted conductive material based on three-dimensional data (hereinafter referred to as a melt extrusion lamination method of conductive material). The heating coil includes a pair of plate-shaped grounding portions for contact with an electrode through which a high-frequency current is flowed, a pair of plate-shaped supporting portions disposed to be perpendicular to the respective grounding portions, and an annular heating unit disposed to connect distal ends of the supporting portions to one another. The annular heating unit has a shape in which a plurality of circumferential heating bodies horizontally disposed at different height positions are coupled by a plurality of vertically disposed columnar heating bodies.

In an invention described in claim 2, which is in the invention described in claim 1, the annular heating unit is formed by coupling the divided five circumferential heating bodies by the four columnar heating bodies.

In an invention described in claim 3, which is in the invention described in claim 1 or 2, sequences of cooling medium flow-down paths to flow down a medium for cooling are formed inside the respective grounding portions, the respective supporting portions, and the heating unit.

### Effects of the Invention

In the heating coil for a high-frequency heater (hereinafter simply referred to as a heating coil) according to claim 1, the annular heating unit has a shape in which a plurality of circumferential heating bodies horizontally disposed at different height positions are coupled by a plurality of vertically disposed columnar heating bodies. Therefore, even when a hardening process is performed on a shaft-shaped material to be worked in which a large diameter portion is continuous with a small diameter portion, a situation in which the annular heating unit continuously generates a large number of magnetic fluxes to the material to be worked at positions close to a groove shoulder part is avoided. Accordingly, the heating coil according to claim 1 can effectively avoid a situation in which a large quantity of current flows at the groove shoulder part of the material to be worked to excessively heat the groove shoulder part, and the hardening process can be uniformly performed on the superficial layer of the material to be worked.

The heating coil according to claim 1 is formed by a partial welding lamination method of conductive material powder layer or a melt extrusion lamination method of conductive material based on three-dimensional data. Therefore, the heating coil can be considerably easily manufactured at low cost regardless of the complicated shape of the annular heating unit. Moreover, products having the same shape and the same characteristics can be efficiently manufactured with good reproducibility regardless of the skill of manufacturing workers. Furthermore, since the heating coil according to claim 1 is formed by a partial welding lamination method of conductive material powder layer or a melt extrusion lamination method of conductive material based on three-dimensional data, a bonding portion with a silver solder is not present different from the conventional heating coil. Therefore, even the temperature rise due to the continuous use does not cause deformation, and the heating process (hardening process) according to specifications can be performed over a long period of time.

In the heating coil according to claim 2, the circumferential heating bodies of the annular heating unit generate an appropriate eddy current in a circumferential direction of the material to be worked, and the columnar heating bodies of the annular heating unit generate an appropriate eddy current in a vertical direction of the material to be worked. Therefore, while the situation in which a large quantity of current flows at the groove shoulder part of the material to be worked to excessively heat the groove shoulder part of the material to be worked is avoided, the hardening process can be efficiently performed on the material to be worked.

In the heating coil for a high-frequency heater according to claim 3, a sequence of cooling medium flow-down paths to flow down a medium for cooling is formed not only inside the annular heating unit, but also inside each of the grounding portions and the supporting portions, and not only the heating unit, but also the grounding portions and the supporting portions are simultaneously cooled during the heating process of the material to be worked. Thus, a portion maintained at high temperature over a long time is not generated. Therefore, since the situation, such as a dielectric breakdown caused by carbonization and/or deterioration of the insulating plate and a damage due to stress concentration to a specific part, is less likely to occur, the heating coil according to claim 3 is excellent in durability, and can undergo the repeated heating process on the material to be worked over a long period of time even under the high output condition.

### BRIEF DESCRIPTION OF THE DRAWINGS

FIG. 1 is a conceptual diagram of a heating unit of a heating coil (in FIG. 1A to FIG. 1C, (i) is a perspective view, (ii) is a side view, and (iii) is a plan view).

FIG. 2 is an explanatory view (vertical cross-sectional view) illustrating an action of the heating coil.

FIG. 3 is a perspective view of the heating coil.

FIG. 4 is a plan view of the heating coil (perspective plan view of a cooling medium flow-down path inside).

FIG. 5 is a cross-sectional view of grounding portions of the heating coil (end view of line A-A of FIG. 4).

FIG. 6 is a cross-sectional view of a supporting portion of the heating coil (end view of line B-B of FIG. 4).

FIG. 7 is an explanatory view illustrating a state of manufacturing the heating coil (FIG. 7A is a plan view, and FIG. 7B is a vertical cross-sectional view).

FIG. 8 is an explanatory view (vertical cross-sectional view) illustrating an action of a conventional heating coil.

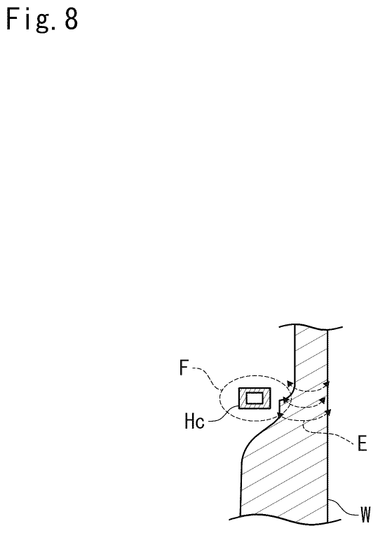

### DESCRIPTION OF PREFERRED EMBODIMENTS

A heating coil according to the present invention requires to be integrally formed by a modeling method based on three-dimensional data using a three-dimensional printer. As the modeling method, a modeling method repeating laying, melting, solidifying, and laminating of a powder containing a conductive material based on three-dimensional data (partial welding lamination method of conductive material powder layer), or a modeling method laminating a melted conductive material based on three-dimensional data (melt extrusion lamination method of conductive material) can be employed. The use of the partial welding lamination method of conductive material powder layer as the heating coil modeling method is preferable because a heating coil having complicated shape and structure can be easily manufactured.

The conductive material used as a raw material of modeling in the present invention means a material that substantially does not have a magnetic property and has satisfactory conductivity. Examples of the conductive material can include copper, brass, and argentum. Among these conductive materials, use of copper is preferable because the cost, such as a material cost, can be reduced to ensure easily manufacturing the heating coil at low price by a three-dimensional printer, and further, the extremely satisfactory conductivity is provided to improve a heat generation efficiency by electromagnetic induction.

When copper is used as the conductive material, while pure copper can be used, use of an alloy (high copper alloy) in which iron, tin, nickel, titanium, beryllium, zirconium, chrome, silicon, or the like is contained in copper with a lower proportion than copper is preferable because laser absorption is increased to allow accelerating temperature rise. Furthermore, among those copper alloys, use of a copper-chrome alloy in which chrome is contained in copper is more preferable because the strength of the heating coil can be effectively enhanced while the production efficiency with the three-dimensional printer is maintained to be high. Use of an alloy (for example, one (high copper alloy) containing 98.71 to 99.45 mass % of copper, 0.50 to 1.00 mass % of chrome, and 0.05 to 0.25 mass % of zirconium) containing chrome and zirconium in copper with predetermined proportions is especially preferable.

When the partial welding lamination method of conductive material powder layer is used to model the heating coil according to the present invention, the laid raw material of modeling (that is, the powder containing the conductive material) needs to be melted by irradiation with a laser or electron beam. As the laser at that time, while a semiconductor laser, a carbon dioxide laser, an excimer laser, a YAG laser, a fiber laser, or the like can be appropriately used, use of the fiber laser (that is, a laser that uses an optical fiber in which a rare earth element, such as Yb, is added as a laser medium) is preferable because a laser light without deviation of optical axis can be obtained at a high output by a small-sized device, and a heating coil with high dimensional accuracy can be considerably efficiently manufactured.

When the partial welding lamination method of conductive material powder layer is used to model the heating coil, while the output and the wavelength of the fiber laser are not specifically limited, the adjustment of the output within a range of 400 to 1,000 W and the adjustment of the wavelength within a range of 1,000 to 1,100 nm are preferable because the efficient modeling in a short time can be performed. When copper (pure copper) is used as the conductive material, to improve the laser absorbance of copper powder for enhancing the production efficiency of the heating coil, an absorbent containing a mixed powder of graphite and an inorganic oxide or the like can be added to the copper powder.

The heating coil according to the present invention needs to include a pair of plate-shaped grounding portions for contact with an electrode through which a high-frequency current is flowed, a pair of plate-shaped supporting portions disposed to be perpendicular to the respective grounding portions, and an annular heating unit disposed to connect distal ends of the supporting portions to one another. While the supporting portions are not specifically limited in shape insofar as they are a pair of plate-shaped (or rod-shaped) ones disposed to be perpendicular to the respective grounding portions, those with chamfered corner portions are preferable for avoiding a discharge phenomenon when an electric power is applied.

On the other hand, while the heating unit needs to be formed in an annular shape, the heating unit is not limited to the annular one, and may be one having a non-annular shape (for example, rectangular shape in plan view) or the like. Then, in the heating coil according to the present invention, the annular heating unit needs to have a shape in which a plurality of circumferential heating bodies horizontally disposed at different height positions are coupled by a plurality of vertically disposed columnar heating bodies. Further, the annular heating unit needs to be internally provided with a cooling medium flow-down path for flowing down a medium for cooling. That is, the circumferential heating bodies and the columnar heating bodies need to form an approximately continuous tube shape (including one having a shape in which a part of the circumferential heating bodies or the columnar heating bodies does not form the tube shape).

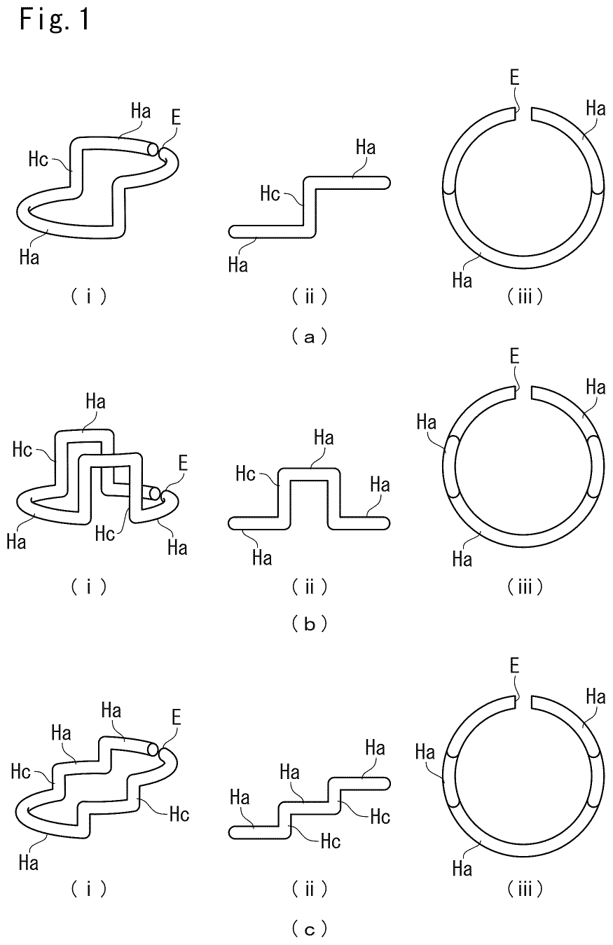

Examples of the annular heating unit having such a shape can include one in which circumferential heating bodies Ha, Ha having shapes (for example, arc shapes) obtained by dividing an annular, for example, circular, body into three portions are arranged in two upper and lower stages and coupled by two vertical columnar heating bodies Hc, Hc as illustrated in FIG. 1A, one in which the circumferential heating bodies Ha, Ha, . . . having shapes obtained by dividing the annular body into five portions are arranged in two upper and lower stages and coupled by the four vertical columnar heating bodies Hc, Hc, . . . as illustrated in FIG. 1B, and one in which the circumferential heating bodies Ha, Ha, . . . having shapes obtained by dividing the annular body into five portions are arranged in three stages in an up-down direction and coupled by the four vertical columnar heating bodies Hc, Hc, . . . as illustrated in FIG. 1C. The above-described annular heating unit can be provided in an aspect in which respective end edges E, E of the adjacent circumferential heating bodies Ha, Ha are coupled to the proximities of distal ends of the left and right supporting portions.

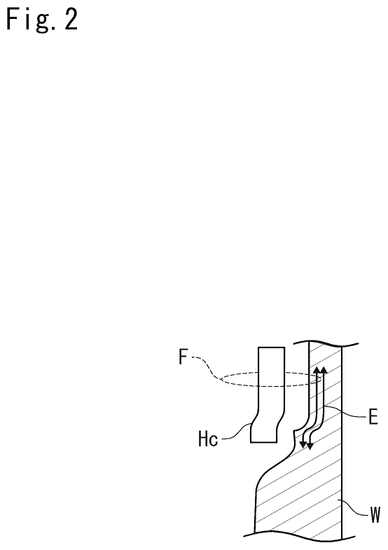

Then, by using the heating coil with the annular heating unit in which the circumferential heating bodies Ha, Ha, . . . divided in the up-down direction are coupled by the columnar heating bodies Hc, Hc, . . . as described above, when a hardening process is performed on a shaft-shaped material to be worked W in which a large diameter portion is continuous with a small diameter portion, a situation in which the circumferential heating bodies Ha, Ha, . . . continuously generate a large number of magnetic fluxes F along a circumferential direction of the material to be worked W at positions close to a groove shoulder part of the material to be worked W as illustrated in FIG. 2 is avoided. Accordingly, a situation in which a large quantity of eddy current E flows at the groove shoulder part of the material to be worked W to excessively heat the groove shoulder part is effectively avoided, and the hardening process can be uniformly performed on the superficial layer of the material to be worked W. Further, since the heating coil according to the present invention is formed by the partial welding lamination method of conductive material powder layer or the melt extrusion lamination method of conductive material based on three-dimensional data, the heating coil according to the present invention can be considerably easily manufactured regardless of the complicated shape of the annular heating unit as described above.

While the heating coil according to the present invention needs to be provided with the cooling medium flow-down path to flow down the medium for cooling inside the heating unit as described above, it is preferable that a sequence of cooling medium flow-down path to flow down the medium for cooling is formed in each of the grounding portions and each of the supporting portions so as to be continuous with the cooling medium flow-down path inside the heating unit. These cooling medium flow-down paths may be a single path disposed to internally connect the left and right grounding portions, the left and right supporting portions, and the heating unit, or may be two paths disposed to internally connect the grounding portions, the supporting portions, and the heating unit in the respective left and right sides of the heating coil.

In addition, the cooling medium flow-down path formed without a seam or a level difference of a predetermined height or more (1.0 mm or more) at the inner wall, or formed with a bent portion and a joining portion in smooth curved shape (curved shape having a curvature radius of 5 mm or more) is preferable because the flow down aspect of the cooling medium becomes considerably smooth, and the cooling efficiency of the grounding portion and the supporting portion of the heating coil becomes extremely satisfactory.

### EXAMPLES

### Example 1

### Structure of Heating Coil

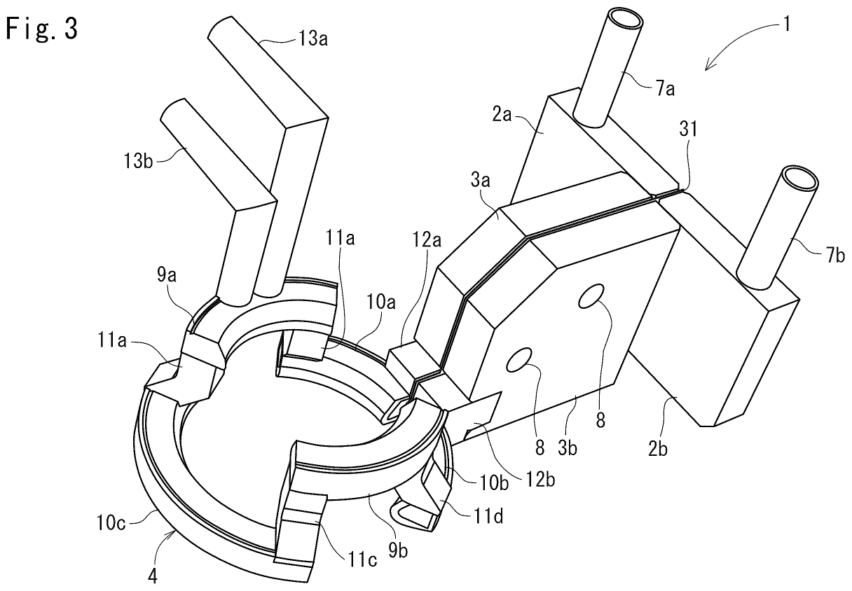

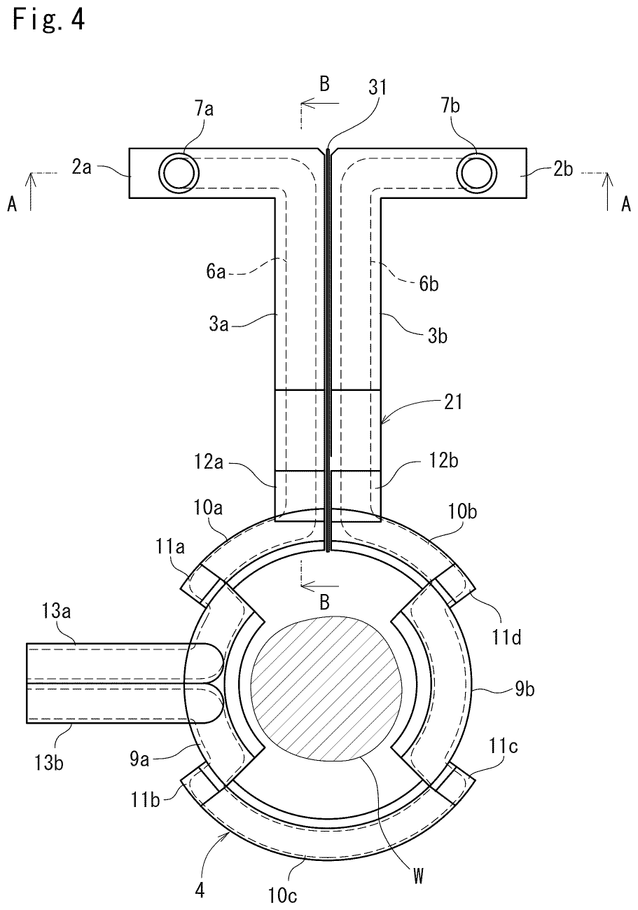

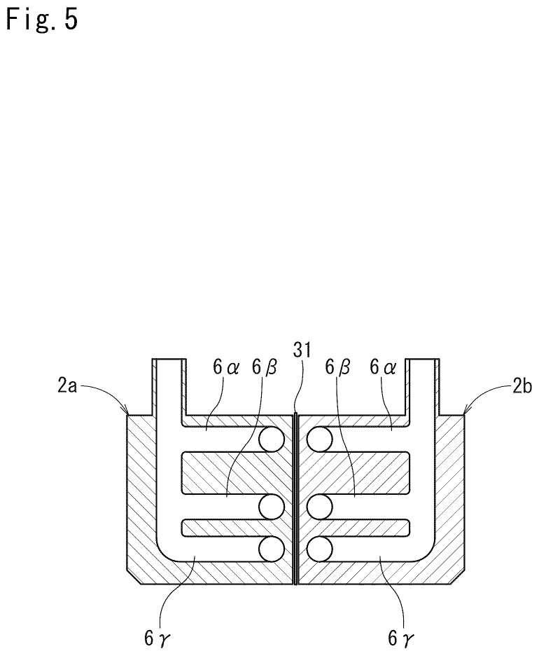

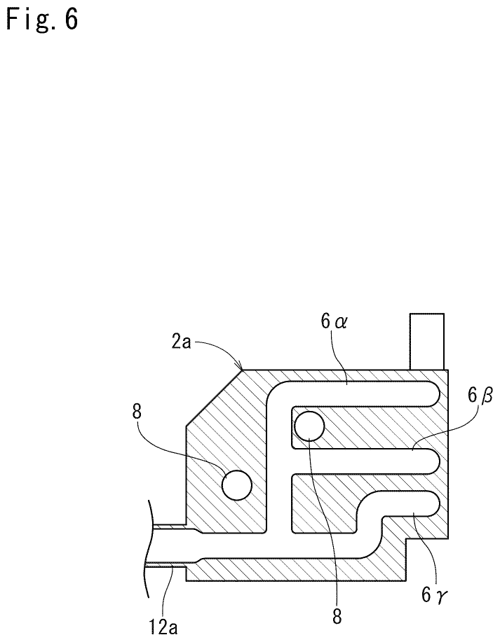

The following describes one embodiment of the heating coil according to the present invention in detail with reference to the drawings. FIG. 3 to FIG. 6 illustrate the heating coil, and a heating coil 1 includes a coil body 21 integrally formed of a copper alloy (high copper alloy), a sheet-shaped insulating plate 31 formed of a synthetic resin (fluororesin) having insulating property and heat resistance, and a screw member (not illustrated). Then, the heating coil 1 has a size of longitudinal length (front-rear)×lateral length (width)×height=300 mm×225 mm×200 mm (lengths of the largest portions in longitudinal side, lateral side, and height).

The coil body 21 is formed by a modeling method using a three-dimensional printer described later, and includes grounding portions 2a, 2b for contact with an electrode of a high-frequency power source, an annular heating unit 4 configured to heat a material to be worked (workpiece) by induction heating, and supporting portions 3a, 3b configured to support the heating unit 4 at positions apart from the grounding portions 2a, 2b, respectively. Since the coil body 21 is formed by the modeling method using a three-dimensional printer, the whole coil body 21 has the same color, and the whole surface has the same roughness (surface roughness).

The grounding portions 2a, 2b are formed in a pair of left and right flat rectangular parallelepiped shapes (plate shapes), and disposed to be adjacent left and right at an interval of a predetermined distance (about 2 mm) having one side surfaces facing to one another. On the upper surfaces of the grounding portions 2a, 2b, cylindrical water discharge pipes 7a, 7b are disposed to project upward, respectively.

The supporting portions 3a, 3b are formed in a pair of left and right flat rectangular parallelepiped shapes (plate shapes), and disposed to be adjacent left and right at an interval of a predetermined distance (about 2 mm) having one plate surfaces facing to one another. Then, the base end edge portions of the supporting portions 3a, 3b are continuous with the proximities of inner end edges of the left and right grounding portions 2a, 2b, respectively, and the plate surfaces of the supporting portions 3a, 3b are perpendicular to the plate surfaces of the grounding portions 2a, 2b, respectively.

### Structure of Heating Unit

On the other hand, the heating unit 4 is configured to heat an inserted material to be worked, and has a shape in which arc-shaped upper circumferential heating bodies 9a, 9b disposed in the upper side and arc-shaped lower circumferential heating bodies 10a to 10c disposed in the lower side are coupled (connected) by vertical four columnar heating bodies 11a to 11d. Then, the upper circumferential heating bodies 9a, 9b and the lower circumferential heating bodies 10a to 10c form a ring shape (annular shape) in plan view. The lower circumferential heating bodies 10a, 10b are disposed to be adjacent left and right at an interval of a predetermined distance (about 2 mm) having inner plate surfaces facing to one another, and form one circular arc. In plan view, each of the upper circumferential heating bodies 9a, 9b, the lower circumferential heating bodies 10a, 10b, and the lower circumferential heating bodies 10c forms an arc of about ⅓ (that is, each of the upper circumferential heating bodies 9a, 9b forms an arc of about ⅙). In addition, the upper circumferential heating bodies 9a, 9b are spaced from the lower circumferential heating bodies 10a to 10c with an interval of about 20 mm. Then, the lower circumferential heating bodies 10a, 10b are connected to distal ends of the left and right supporting portions 3a, 3b via tubular coupling bodies 12a, 12b, respectively.

Both of the upper circumferential heating bodies 9a, 9b and the lower circumferential heating bodies 10a to 10c have a vertical cross-sectional shape perpendicular to the longitudinal direction in a (chamfered rectangular shape having round corners). Then, on the upper surface of the upper circumferential heating body 9a, an inner injection pipe 13a and an outer injection pipe 13b for injecting the cooling medium from outside are disposed to extend upward along the vertical direction.

In addition, the heating coil 1 is provided with the cooling medium flow-down path to flow down the medium (water) for cooling inside the heating unit 4 (that is, the upper circumferential heating bodies 9a, 9b, the lower circumferential heating bodies 10a to 10c, and the columnar heating bodies 11a to 11d) (that is, the upper circumferential heating bodies 9a, 9b, the lower circumferential heating bodies 10a to 10c, and the columnar heating bodies 11a to 11d form a tube shape). Further, the heating coil 1 includes two left and right sequences of cooling medium flow-down paths 6a, 6b for flowing down the medium for cooling inside not only the heating unit 4, but also the grounding portions 2a, 2b and the supporting portions 3a, 3b so as to be continuous with the inside of the heating unit 4.

That is, the cooling medium flow-down path 6a in the left side reaches the left side water discharge pipe 7a from the inner injection pipe 13a passing through inside the upper circumferential heating body 9a, inside the left rear columnar heating body 11a, inside the lower circumferential heating body 10a, inside the coupling body 12a, inside the left side supporting portion 3a, and the left side grounding portion 2a. On the other hand, the cooling medium flow-down path 6b in the right side reaches the right side water discharge pipe 7b from the outer injection pipe 13b passing through inside the upper circumferential heating body 9a, inside the left front columnar heating body 11b, inside the lower circumferential heating body 10c, inside the right front columnar heating body 11c, inside the right upper circumferential heating body 9b, inside the right rear columnar heating body 11d, inside the lower circumferential heating body 10b, inside the coupling body 12b, inside the right side supporting portion 3b, and the right grounding portion 2b. The left side cooling medium flow-down path 6a and the right side cooling medium flow-down path 6b are each branched into three paths (6α, 6β, 6γ) in the supporting portions 3a, 3b once, and the three paths (6α, 6β, 6γ) are separately introduced to the inside of the left and right grounding portions 2a, 2b, then combined into one path in the grounding portions 2a, 2b.

Since the heating coil 1 is integrally formed by the three-dimensional printer, in both of the cooling medium flow-down path 6a in the left side and the cooling medium flow-down path 6b in the right side, the bent portions and the joining portions are all formed in the smooth curved shape (curved shape having a curvature radius of 5 mm or more), and there is no steeply bent shape. In addition, both the cooling medium flow-down path 6a in the left side and the cooling medium flow-down path 6b in the right side have no seam or level difference of a predetermined height (1.0 mm) or more at the inner wall.

Furthermore, the sheet-shaped insulating plate 31 having a predetermined thickness (about 2.0 mm) is interposed between the left and right grounding portions 2a and 2b and between the left and right supporting portions 3a and 3b of the coil body 21, between the left and right lower circumferential heating bodies 10a, 10b of the heating unit 4, and between the left and right coupling bodies 12a and 12b, and in this state, the left and right supporting portions 3a, 3b and the insulating plate 31 are screwed together by bolts (not illustrated) inserted through screw-holes 8, 8. These bolts screw the supporting portions 3a, 3b and the insulating plate 31 together via bushes (not illustrated) made of a synthetic resin (glass epoxy resin) having insulating property and heat resistance, and are configured to avoid conduction between the supporting portions 3a and 3b via the bolts.

### Manufacturing Method of Heating Coil

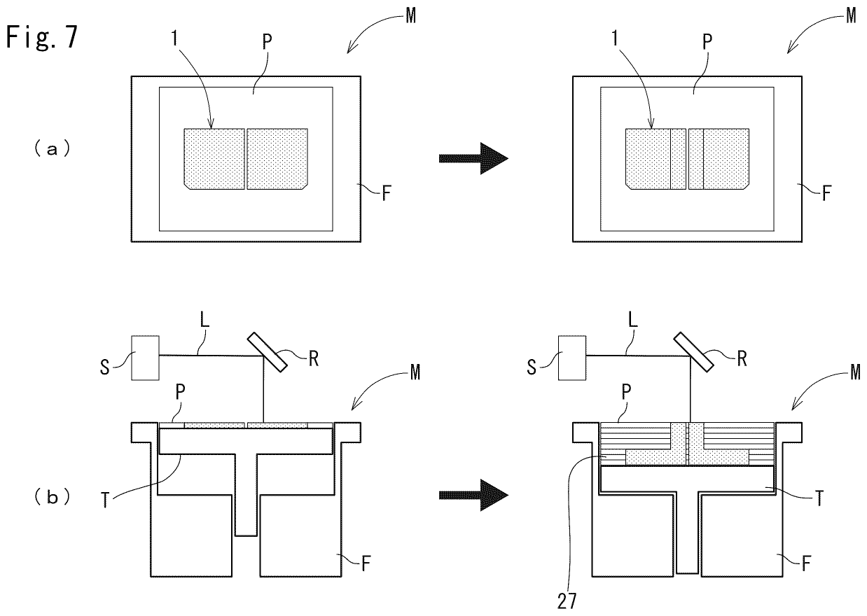

FIG. 7 illustrates a state of forming the heating coil 1, and a three-dimensional printer device M for forming the heating coil 1 includes a frame F provided with a rectangular parallelepiped recessed portion in the center, an elevating member disposed to be movable up and down with respect to the frame F, irradiation means S configured to emit a laser L, reflection means R configured to reflect the laser, and driving means (not illustrated) configured to move up and down the elevating member. Then, the elevating member is provided with a table T having approximately the same area as an opening portion of the recessed portion of the frame F.

In the manufacture of the heating coil 1 by the three-dimensional printer device M, first, a powder of copper alloy (high copper alloy) is laid with a predetermined thickness (for example, 30 μm) on the surface of the table T of the elevating member at an elevated position (the copper powder is laid by an amount of a gap between the surface of the table T and a surface of an outer frame of the frame F). Then, the copper alloy powder is irradiated with the laser (fiber laser) L of a predetermined output in a predetermined shape to melt a part of the copper alloy powder, which is cooled and solidified, thereby forming a part of the heating coil 1.

After the formation of a part of the heating coil 1 as described above, the table T of the elevating member is moved down by a predetermined height (for example, 30 μm) by the driving means. Then, at the height position, the operation of “laying the copper alloy powder→irradiating the copper alloy powder with the laser→cooling and solidifying the melted copper alloy (solidification by coagulation) at the upper side of the part of the previously formed heating coil 1” is repeated. Then, as described above, the operation of “moving down the table T of the elevating member→laying the copper alloy powder→irradiating the copper alloy powder with the laser L→cooling and solidifying the melted copper alloy” is repeated by a predetermined number of times (for example, 5,000 times), thereby allowing integrally forming the heating coil 1 made of a copper alloy.

### Use Method of Heating Coil

The heating coil 1 configured as described above can heat a material to be worked by, in a state where the left and right grounding portions 2a, 2b are grounded to the electrode, and a material to be worked is inserted inside the annular portion (that is, the ring formed by the upper circumferential heating bodies 9a,9b and the lower circumferential heating bodies 10a to 10c) of the heating unit 4, turning on an external power source (high-frequency power source) via the electrode and using an electromagnetic induction phenomenon. Additionally, by injecting a cooling medium (water) into the left side cooling medium flow-down path 6a from the inner injection pipe 13a and discharging from the water discharge pipe 7a, and injecting the cooling medium into the right side cooling medium flow-down path 6b from the outer injection pipe 13b and discharging from the water discharge pipe 7b, the grounding portions 2a, 2b and the supporting portions 3a, 3b are efficiently cooled together with the heating unit 4, thereby allowing avoiding a situation, such as a damage due to the melted insulating plate 31.

### Effect of Heating Coil

In the heating coil 1, as described above, the annular heating unit 4 has the shape in which the plurality of circumferential heating bodies Ha, Ha, . . . horizontally disposed at different height positions are coupled by the plurality of vertically disposed columnar heating bodies Hc, Hc, . . . Therefore, even when a hardening process is performed on a shaft-shaped material to be worked W in which a large diameter portion is continuous with a small diameter portion, a situation in which the annular heating unit 4 continuously generates a large number of magnetic fluxes along a circumferential direction of the material to be worked W at positions close to a groove shoulder part of the material to be worked W is avoided. Accordingly, a situation in which a large quantity of current flows at the groove shoulder part of the material to be worked W to excessively heat the groove shoulder part can be effectively avoided, and the hardening process can be uniformly performed on the superficial layer of the material to be worked W.

Further, since the heating coil 1 is formed by the modeling method (that is, partial welding lamination method of conductive material powder layer based on three-dimensional data) using the three-dimensional printer device M, the heating coil 1 can be considerably easily manufactured regardless of the complicated shape of the annular heating unit 4. Moreover, products having the same shape and the same characteristics can be efficiently manufactured with good reproducibility regardless of the skill of manufacturing workers. Furthermore, since the heating coil 1 is formed by the modeling method using the three-dimensional printer device M, a bonding portion with a silver solder is not present different from the conventional heating coil. Therefore, even the temperature rise due to the continuous use does not cause deformation, and the heating process (hardening process) according to specifications can be performed over a long period of time.

Furthermore, in the heating coil 1, the annular heating unit 4 is formed by coupling the divided five circumferential heating bodies Ha, Ha, . . . by the four columnar heating bodies Hc, Hc, . . . the circumferential heating bodies Ha, Ha, . . . generate the appropriate eddy current in the circumferential direction of the material to be worked W, and the columnar heating bodies Hc, Hc, . . . generate the appropriate eddy current in the vertical direction of the material to be worked W. Therefore, while the situation in which a large quantity of current flows at the groove shoulder part of the material to be worked W to excessively heat the groove shoulder part of the material to be worked W is avoided, the hardening process can be efficiently performed on the material to be worked W.

In addition, the heating coil 1 is provided with the sequences of cooling medium flow-down paths 6a, 6b for flowing down the cooling medium not only inside the heating unit 4 but also inside the respective grounding portions 2a, 2b and the respective supporting portions 3a, 3b. Therefore, not only the heating unit 4 but also the respective grounding portions 2a, 2b and the respective supporting portions 3a, 3b are simultaneously cooled during the heating process of the material to be worked W, and a situation of being kept at high temperature over a long period of time does not occur. Therefore, since the situation, such as a dielectric breakdown caused by carbonization and/or deterioration of the insulating plate 31 and a damage due to stress concentration to a specific part, does not occur, the heating coil 1 is excellent in durability, and can undergo the repeated heating process on the material to be worked W over a long period of time even under the high output condition.

Furthermore, the heating coil 1 includes the discharge ports 7a, 7b for discharging the cooling medium from the cooling medium flow-down paths 6a, 6b at the grounding portions 2a, 2b. Therefore, the mounting portion of the heating coil in the high-frequency heater can be compactly designed with a small space, and the installation to and removal from the high-frequency heater main body is facilitated.

The heating coil 1 includes the injection ports 13a, 13b for injecting the cooling medium into the cooling medium flow-down paths 6a, 6b at the heating unit 4, and the heating unit 4 likely to become the highest temperature can be supplied with the cooling medium at low temperature immediately after introduction from the water source.

Therefore, the heating coil 1 is extremely excellent in cooling efficiency, and can be used in a state of being applied with a high-frequency power supply at a considerably high output.

### Modification of Heating Coil

The heating coil according to the present invention is not limited to the above-described aspect of the embodiment, and the configuration, such as a material, and shapes and structures of the grounding portion, the supporting portion, and the annular heating unit (circumferential heating body, columnar heating body), can be appropriately changed as necessary without departing from the gist of the present invention.

For example, the annular heating unit is not limited to one in which the arc-shaped circumferential heating bodies divided into five portions are disposed in the two upper and lower stages and coupled by the four vertical columnar heating bodies as described above, and can be changed to one in which the arc-shaped circumferential heating bodies divided into five portions are disposed in three stages in the up-down direction, or one in which the arc-shaped circumferential heating bodies divided into seven portions are disposed in four stages in the up-down direction. The annular heating unit is not limited to one including the circumferential heating bodies coupled to the supporting portions at right and left distal ends of the supporting portions at the same height as described above, and can be changed to one including the circumferential heating bodies coupled to the supporting portions at right and left distal ends of the supporting portions at different heights.

Furthermore, the heating coil according to the present invention is not limited to one including a plurality of cooling medium flow-down paths as the above-described embodiment, and may be changed to, for example, one including a single cooling medium flow-down path (for example, one reaching a heating unit in one side from an injection pipe in the same side via a grounding portion and a supporting portion in the same side and reaching an injection pipe in the opposite side from the heating unit via a supporting portion and a grounding portion in the opposite side).

In addition, the heating coil according to the present invention is not limited to one in which the insulating plate made of a fluororesin (PTFE, PFA, FEP, ETFE, PCTFE, ECTFE, PVDF) insulates between a pair of grounding portions and between a pair of supporting portions as the above-described embodiment, and may be changed to, for example, one in which the insulating plate made of another synthetic resin having insulation property and heat resistance, such as polyacetal (POM), polyphenylene sulfide (PPS), and polyetheretherketone (PEEK), insulates between the pair of grounding portions and between the pair of supporting portions.

### INDUSTRIAL APPLICABILITY

The heating coil according to the present invention provides the excellent effects as described above, and therefore, can be appropriately used as a member for heating a material to be worked using electromagnetic induction.

### DESCRIPTION OF REFERENCE SIGNS

1 . . . Heating coil
2a, 2b . . . Grounding portion
3a, 3b . . . Supporting portion
4 . . . Heating unit
Ha . . . Circumferential heating body
Hc . . . Columnar heating body
6a, 6b . . . Cooling medium flow-down path
7a, 7b . . . Discharge pipe
13a . . . Inner injection pipe
13b . . . Outer injection pipe
14 . . . Injection pipe
15 . . . Discharge pipe

1. A heating coil used for a high-frequency heater configured to heat a material to be worked using electromagnetic induction by a high-frequency current, wherein
the heating coil is integrally formed by a modeling method repeating laying, melting, solidifying, and laminating of a powder containing a conductive material based on three-dimensional data, or a modeling method laminating a melted conductive material based on three-dimensional data, and
the heating coil comprises:
a pair of plate-shaped grounding portions for contact with an electrode through which a high-frequency current is flowed;
a pair of plate-shaped supporting portions disposed to be perpendicular to the respective grounding portions; and
an annular heating unit disposed to connect distal ends of the supporting portions to one another, wherein
the annular heating unit has a shape in which a plurality of circumferential heating bodies horizontally disposed at different height positions are coupled by a plurality of vertically disposed columnar heating bodies.

2. The heating coil for a high-frequency heater according to claim 1, wherein
the annular heating unit is formed by coupling the divided five circumferential heating bodies by the four columnar heating bodies.

3. The heating coil for a high-frequency heater according to claim 1, wherein
sequences of cooling medium flow-down paths to flow down a medium for cooling are formed inside the respective grounding portions, the respective supporting portions, and the heating unit.

4. The heating coil for a high-frequency heater according to claim 2, wherein
sequences of cooling medium flow-down paths to flow down a medium for cooling are formed inside the respective grounding portions, the respective supporting portions, and the heating unit.
